(19) United States
(12) Patent Application Publication
(10) Pub. No.: US 2013/0291831 A1
(43) Pub. Date: Nov. 7, 2013

(54) METHOD AND DEVICE FOR THE SEPARATE LUBRICATION OF AN INTERNAL COMBUSTION ENGINE

(71) Applicant: SOLO Kleinmotoren Gmbh, Sindelfingen (DE)

(72) Inventors: Samuel Schinkel, Magstadt (DE); Volker Rümelin, Herrenberg (DE)

(21) Appl. No.: 13/923,783

(22) Filed: Jun. 21, 2013

Related U.S. Application Data
(63) Continuation of application No. PCT/EP2011/067574, filed on Oct. 7, 2011.

(30) Foreign Application Priority Data
Dec. 21, 2010 (DE) 102010055387.5

(51) Int. Cl. F02D 45/00

(52) U.S. Cl. CPC F02D 45/00
USPC 123/395

(57) ABSTRACT

The invention relates to a method and device, with the aid of which the monitoring of the oil supply to an internal combustion engine, which operates according to a two-stroke cycle, can be optimized.

### CROSS-REFERENCE TO RELATED APPLICATIONS

This application is a continuation of International Application No. PCT/EP2011/067574, filed on Oct. 7, 2011, which claims the benefit of DE 10 2010 055 387.5, filed on Dec. 21, 2010. The disclosures of the above applications are incorporated herein by reference.

### FIELD

Hand-held motorized devices, such as, for example separating cutters and chain saws, are frequently equipped with combustion engines operating on the two-cycle principle. An important advantage of two-cycle engines is their compact and light manner of construction. In order to be able to lubricate the three moving parts of a piston-port, two-cycle engine, namely the piston, the piston rod, and the crankshaft, the suctioned combustion air is mixed with the oil required for lubrication. This can occur, for example, by mixing oil with fuel, or it can occur by a so-called separate lubrication. In the separate lubrication, a separate oil tank is present. The oil is suctioned from this oil tank via a lubricating oil pump and is moved into the suction cycle or directly into the crankcase of the combustion engine.

### BACKGROUND

The statements in this section merely provide background information related to the present disclosure and may not constitute prior art.

This separate lubrication has been implemented in many applications and areas of use of two-cycle engines, since it enables a better exhaust behavior and in addition is simpler and more reliable, especially when used on construction sites and in forestry.

Known from WO 2009/004088 A2 is a separating grinding device which features a two- cycle engine with separate lubrication. During this separate lubrication, the electric lubricating oil pump is controlled by a first control device. In the process, the flow rate of the lubricating oil pump is regulated according to the oil requirement of the combustion engine. Thus the flow quantity can be controlled, for example, by the rotational speed of the combustion engine.

The movement of lubricating oil is monitored by the lubrication oil pump in this separate lubrication as known from the prior art. If no lubricating oil is moved, the ignition is shut off or the rotational speed of the combustion engine is limited to the idling rotational speed.

### SUMMARY

The object of the invention is to further improve a method and a device for separate lubrication of a two-cycle engine, in order firstly to ensure a secure supply of oil to the combustion engine and secondly, to avoid longer work interruptions due to a lack of oil.

This object is inventively achieved by a method of operating a combustion engine, so that the rotational speed of the combustion engine is limited to a regulated rotational speed which is above the idling rotational speed and below the nominal rotational speed of the combustion engine, if the supplying of the combustion engine with oil is not assured, wherein the combustion engine encompasses an oil pump, a first control device for the oil pump, and an ignition device, wherein the oil pump is so controlled by the first control device that the combustion engine is sufficiently supplied with oil, and wherein the supply of oil to the combustion engine is monitored.

This method has the advantage that by means of the speed regulation of the combustion engine to an intermediate rotational speed which lies between the nominal rotational speed and the idling rotational speed, more information can be sent to the operator of the engine-powered device. The operator receives the information that the combustion engine is still capable of functioning and that the oil supply or the oil tank must be filled. This information eases the work at construction sites, primarily if the operating instructions are not available or were not studied for reasons of time.

The moderated and regulated rotational speed is thus a clear and easily understood signal to the operator that no defect is present but instead only the oil must be refilled.

The method of the present disclosure can also be used with chain saws to regulate oil needed for the saw chain.

Another advantage of this moderated and regulated rotational speed can be seen in the fact that with an under-supply of oil to the combustion engine, the oil pump can be so controlled that it reaches its maximum flow rate and thus the oil supply deficiency for the combustion engine is eliminated as quickly as possible. On the other hand, it is ensured that the operator of the device will not continue to work, because at the regulated rotational speed there is not enough power available, for example, to cut through stone plates using the separating grinder or to operate a chain saw.

Because the inventive method does not require any additional display instruments or devices, it is not only very effective but also very reliable.

An alternative method of operating a combustion engine envisions that in the event of an inadequate supply of oil to the combustion engine, the oil pump is so controlled that the maximum oil quantity is delivered in order replenish the supply of oil to the combustion engine as quickly as possible.

Furthermore, in another advantageous embodiment the reduction of the rotational speed of the combustion engine to the regulated rotational speed is implemented.

The operating rotational speeds of two-cycle engines which are built into hand-held engine-powered devices usually reside above 8,000 revolutions per minute. A regulated rotational speed in the range between 2,000/min and 6,000/min, but preferably between 3,500/min and 4,500/min, has proven advantageous. At this regulated rotational speed the electric supply to the first control device is guaranteed in any case and sufficient electric energy is available to bring an electrically or mechanically powered oil supply pump to a maximum pumping capacity.

In an advantageous embodiment of the inventive method, the supply of oil to the combustion engine is monitored by an optical sensor or a capacitive sensor. It is also alternatively possible that the supply of oil to the combustion engine occurs by monitoring of the time progression of current consumption by the electrically powered oil pump. In this case it often happens that the quantity delivered by the electrically powered oil pump is controlled by means of a modulated square-wave voltage signal in the form of a so-called pulse-width modulation. Depending on whether oil or air is delivered, the time progression of the electric current consumed by the oil pump changes. Thus by monitoring the time progression of current consumed by the electric oil pump it is possible to draw conclusions about whether the oil pump is moving oil or air and to use this appropriately in the inventive method.

The regulated rotational speed assured through the invention can be limited so that, for example, an ignition spark is only produced at every second or third ignition top dead center (TDC). Alternatively or in addition, the ignition point in time can also be adjusted.

The object named at the outset is so achieved by a control device for an oil pump of a combustion engine with a first electric output to control the supply quantity of an oil pump, with a second electric output for communication with an ignition mechanism of a combustion engine, and with means to monitor the oil supply of a combustion engine, that the means to monitor the oil supply are integrated into the first control unit. Consequently a check is made to determine whether the oil pump is delivering oil, but also whether this oil is flowing through a tube to the combustion engine. This tube, which usually connects the oil pump to the suction cycle of the combustion engine or to the crankcase of the combustion engine, is separated to a certain extent by the control device so that the oil flows through the control device. This can be accomplished as a result of the control device having two connection fittings on which the two separate ends of the tube are attached. This means that all the oil moved by the pump flows through a corresponding small tube in the control device.

If this small tube is of a transparent material, then an optical sensor can be integrated into the control unit which determines whether oil or air is located in the line and emits a corresponding output signal to the microprocessor of the control device. Alternatively a capacitive sensor can also be used instead of the optical sensor. This capacitive sensor also determines whether oil or air is located in the small tube and emits an appropriate output signal to the microprocessor of the control device.

Another possibility to determine whether oil or air is delivered is then attained if the oil pump is electrically powered. The control of the electrical power of the oil pump likewise occurs via a control device and can be evaluated. If the oil pump delivers air, then the current consumption of the electric power is different than when oil is delivered. This also means that by monitoring the current consumed by the electric drive of the oil pump, it can be determined whether the pump is delivering oil or air. All these means to monitor the oil supply of the combustion engine are inventively integrated into the control device, so that there is a very compact, cost-effective, and at the same time an operationally secure design.

It has also proven advantageous, when the oil feed/supply line or the tube from the oil pump which delivers the oil into the combustion engine empties in the carburetor. This is therefore especially advantageous with hand-held devices, because the carburetor is arranged so as to be decoupled from the actual combustion engine by vibrations at the so-called grip-unit of the engine-powered device.

The first control device and the oil pump are fastened on the frame of the device and also decouple from the actual combustion engine because of vibrations, so that no relative movements occur between the oil pump, the first control device, and the carburetor. As a result, the danger of leaking tubes due to continuous mechanical stress or abrasion is definitely reduced.

Other advantages and embodiments of the invention can be taken from the following drawings and their description. All features disclosed in the drawings, their description, and the patent claims can be used individually or also in any desired combination with each other.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an oil pump and control device assembly for the inventive separate lubrication according to the present disclosure; and

FIG. 2 is a flow diagram of an inventive method of operating a combustion engine with separate lubrication according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

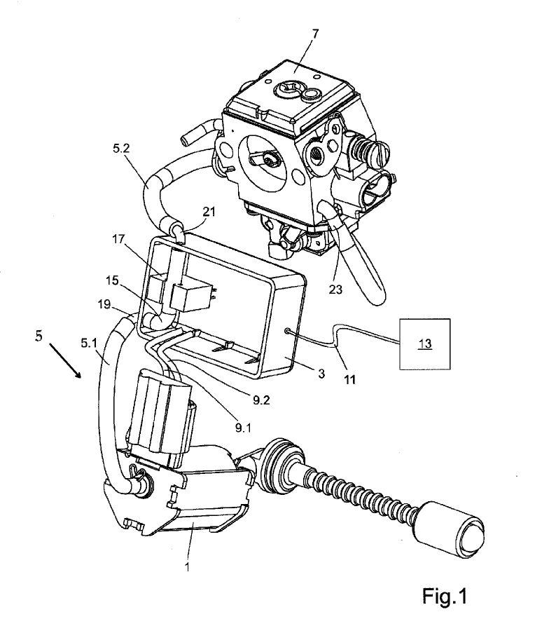

FIG. 1 is a perspective view of an oil pump and control device assembly illustrating an inventive method of operating a combustion engine with separate lubrication. The separate lubrication includes an electrically operated oil pump 1, a first control device 3, and an oil feed line 5. The oil feed line 5 is divided into sections 5.1 and 5.2. It empties into a carburetor 7 of a combustion engine (not shown). The carburetor 7 is preferably electrically operated. The first control device 3 is depicted as partially cut open.

The first control device 3 is connected to the electric power of the oil pump 1 via a first electric connection 9.1 and 9.2. In addition, the first control device 3 is electrically connected via a signal line 11 to an ignition mechanism (not depicted), preferably an ignition box of an ignition mechanism. The ignition box 13 of the ignition mechanism requires a release signal from the first control device 3. Without this release signal, the ignition box 13 prevents the combustion engine from reaching its operational rotational speed.

An oil line 15 and an optical sensor 17 can be seen to be in the cut open part of the first control device 3. The oil line 15 is made of a transparent material, preferably a plastic, and is terminated outside the first control device 3 in the form of connection fittings 19 and 21. The first partial piece 5.1 of the tube is attached to the first connection fitting 19 which is connected at its other end to the oil pump 1. The second section 5.2 of the tube 5 is attached to the second connection fitting 21. The other end of the second section 5.2 is fastened to a third fitting 23 on the carburetor 7.

This means that the oil delivered by the oil pump 1 is guided through the housing of the first control device 3. The optical sensor 17 surrounds at least the areas of the oil line 15 and is therefore able to recognize whether oil or air is in the oil line 15. If oil is in the oil line 15, the optical sensor 17 emits an appropriate output signal to the microprocessor (not depicted) located in the first control device 3 and provides a signal indicating that nothing is preventing operation of the combustion engine at the nominal rotational speed. Therefore, the first control device 3 sends a release signal across the signal line 11 to the ignition box 13 of the ignition mechanism which controls the ignition accordingly.

If the optical sensor 17 detects air in the oil line 15, the output signal of the optical sensor 17 changes and the first control device 3 registers this. As a result, the first control device 3 sends an appropriate non-release signal to the ignition box 13 via the signal line 11. As a result, the rotational speed of the combustion engine is limited to a predetermined regulated rotational speed, for example, in the range between 2,000 and 6,000 revolutions, preferably in a range between 3,500 and 4,500 revolutions per minute. As a result, the operator of the handheld device, for example a separating grinder or a chainsaw, haptically and acoustically receives the message that the oil supply to the combustion engine is not assured (i.e., the amount of oil supply is not within a predetermined amount).

The first control device 3 simultaneously sends a control signal to the oil pump 1, so that the pumping capacity of the pump 15 is maximized. As a result, any oil possibly still present in the oil tank (not depicted) can be pumped and the supply of lubricant to the combustion engine is assured.

It has proven advantageous if the rotational speed of the combustion engine is regulated immediately upon the presence of an air bubble in the oil line 15. It is also advantageous if the transmission of the non-release signal via the signal line 11 to the ignition box 13 occurs in a delayed manner. As a practical matter, 15 or 25 seconds, for example, have turned out to be expedient delay times. This will prevent that the mere presence of a small air bubble in the oil line 15 results in an interruption of work.

Regardless of the delay time, it is advantageous if the delivery capability of the oil pump 1 is maximized immediately after an air bubble is detected in the oil line 15. Consequently, this ensures that the combustion engine will be adequately supplied with oil.

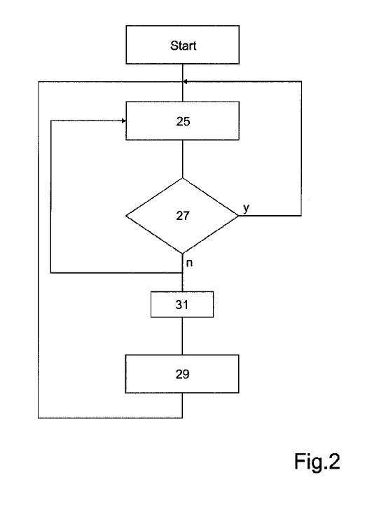

FIG. 2 shows a flow diagram of an inventive method according to the present disclosure. The inventive method begins immediately upon the start of the combustion engine. The control of the oil pump 1 is undertaken in a first bock 25. The delivery quantity of the oil pump 1 can be controlled as a function of a characteristic curve or a characteristic diagram or simply by means of the rotational speed of the combustion engine or the intake quantity of fuel.

In block 27 a check is run to determine whether the oil supply of the combustion engine is in order. This check and monitoring of the oil supply take place according to the invention inside the first control device 3, for example with the help of a first optical sensor 17. If the result of this monitoring is positive (oil supply is in order), then the inventive method returns to the first block 25.

If it is determined in block 27 that the oil supply is not in order, then the program branches into one or two other loops. In a first loop, the procedure leads back to block 25 where the control of the oil pump occurs. As a result, the oil pump 1 is so controlled that the oil pump 1 delivers a maximum delivery quantity so that any inadequate oil supply that may possibly occur is improved as quickly as possible.

Alternatively or additionally, a corresponding output signal is transmitted to the ignition box 13 via the signal line 13 to regulate the rotational speed of the engine due to an inadequate oil supply. For example, a suitable regulated rotational speed can amount to 4,000 revolutions per minute. It can thereby be advantageous if the regulation of the engine first occurs in a function block 29, when a delay time 31 is completed. The purpose of this delay time 31 is to reduce the rotational speed of the combustion engine at function block 29 only after expiration of an adjustable period of time of, for example, 15 seconds, during which the oil supply to the combustion engine is not in order.

It is thereby prevented that upon the detection of a small air bubble in the oil line 15 the combustion engine speed is reduced and work is interrupted. A brief deficiency in the supply of oil to the combustion engine has no negative effects of the operating life of the combustion engine.

After the rotational speed of the combustion engine is regulated in function block 29, the procedure branches again into a point above function block 25 in which the oil pump 1 is controlled (see block 25) and the procedure begins again.

As soon as the pumping capacity is sufficient to ensure a sufficient oil supply, the procedure again branches at function block 27 to the Y-branch and the procedure begins anew above the first function block 25.

The regulation of the engine (see function block 29) and the increase of the delivery rate can be used independently or cumulatively to protect the combustion engine, to restore the oil supply as quickly as possible, and to simultaneously send information in a message to the operator of the device that the oil tank must be filled.

What is claimed is:

1. A method of operating a combustion engine with an oil pump, comprising:
monitoring a supply of oil from the oil pump to the combustion engine; and
limiting a rotational speed of the combustion engine to a regulated rotational speed which is above an idling rotational speed and below a nominal rotational speed when the supply of the oil to the combustion engine is not assured.

2. The method according to claim 1, further comprising controlling the oil pump to increase the supply of the oil to the combustion engine when the supply of the oil to the combustion engine is not assured.

3. The method according to claim 1, wherein the regulated rotational speed is in a range between 2,000/min and 6,000/min, preferably between 3,500/min and 4,500/min.

4. The method according to claim 1, wherein a delivery quantity of the oil pump is controlled by means of a modulated square-wave voltage signal (PMW).

5. The method according to claim 1, wherein the oil supply to the combustion engine is monitored by evaluation of a time progression of an electric current consumed by the oil pump.

6. The method according to claim 1, further comprising producing an ignition spark at every second or third ignition Top Dead Center (TDC) to limit the rotational speed of the combustion engine.

7. The method according to claim 1, further comprising adjusting an ignition timing to limit the rotational speed of the combustion engine.

8. A method of operating a combustion engine with an oil pump, comprising:
monitoring a supply of oil from the oil pump to the combustion engine; and
controlling the oil pump to increase the oil supply to the combustion engine when the oil supply to the combustion engine is not assured.

9. The method according to claim 8, further comprising limiting the rotational speed of the combustion engine to a regulated rotational speed when the oil supply to the combustion engine is not assured.

10. The method according to claim 9, wherein the regulated rotational speed is in a range between 2,000/min and 6,000/min, preferably between 3,500/min and 4,500/min.

11. The method according to claim 8, wherein the oil supply to the combustion engine is monitored by an optical sensor or a capacitive sensor.

12. The method according to claim 8, wherein the delivery quantity of the oil pump is controlled by means of a modulated square-wave voltage signal (PMW).

13. The method according to claim 8, wherein the oil supply to the combustion engine is monitored by evaluation of a time progression of an electric current consumed by the oil pump.

14. The method according to claim 8, wherein the rotational speed of the combustion engine is so limited that an ignition spark is produced at every second or third ignition TDC.

15. The method according to claim 8, wherein the rotational speed of the combustion engine is so limited that the ignition timing is adjusted.

16. A control device for an oil pump of a combustion engine, comprising:
a first electric output to control a delivery quantity of the oil pump;
a second electric output for communication with an ignition mechanism; and
means to monitor oil supply of the combustion engine, wherein the means to monitor the oil supply are integrated into the control device.

17. The control device according to claim 16, wherein the means to monitor the oil supply includes an optical sensor integrated into the control device and/or a capacitive sensor.

18. The control device according to claim 16, wherein the means to monitor the oil supply monitors an electric current flowing through the first output.
